(19) United States
(12) Patent Application Publication
(10) Pub. No.: US 2015/0378886 A1
(43) Pub. Date: Dec. 31, 2015

(54) SOFTWARE-DEFINED SSD AND SYSTEM USING THE SAME

(71) Applicant: Avalanche Technology, Inc., Fremont, CA (US)

(72) Inventors: Siamack Nemazie, Los Altos Hills, CA (US); Mehdi Asnaashari, Danville, CA (US); Ruchirkumar D. Shah, San Jose, CA (US)

(21) Appl. No.: 14/679,956

(22) Filed: Apr. 6, 2015

Related U.S. Application Data
(63) Continuation of application No. 14/679,823, filed on Apr. 6, 2015.
Application No. 14/679,823 is a continuation-in-part of application No. 14/678,777, filed on Apr. 3, 2015.
Application No. 14/678,777 is a continuation-in-part of application No. 14/073,669, filed on Nov. 6, 2013, now Pat. No. 9,009,397.
Application No. 14/073,669 is a continuation-in-part of application No. 14/629,404, filed on Feb. 23, 2015.
Application No. 14/629,404 is a continuation-in-part of application No. 13/858,875, filed on Apr. 8, 2013.
Application No. 13/858,875 is a continuation-in-part of application No. 14/595,170, filed on Jan. 12, 2015.
Application No. 14/595,170 is a continuation of application No. 14/040,280, filed on Sep. 27, 2013, now Pat. No. 8,954,657.
(60) Provisional application No. 62/064,845, filed on Oct. 16, 2014.

(51) Int. Cl. G06F 12/02

(52) U.S. Cl. CPC G06F 12/0246; G06F 12/0253; G06F 2212/1056; G06F 2212/2022; G06F 2212/7201; G06F 2212/7205

(57) ABSTRACT

Flash geometry information of the solid state disk (SSD) is maintained as is a logically-addressable SSD (laSSD) geometry information of the SSD. Based on the flash geometry and the laSSD geometry, virtual super blocks are configured by dynamically binding logical SSD logical block addresses (SLBAs) of a virtual super block with a physical super block within the laSSD. A virtual super block is made of a number of virtual blocks and each virtual block made of a number of virtual pages. Each of the virtual blocks corresponds to a physical block of a physical super block within the laSSD such that the virtual pages of the virtual block correspond to like physical pages of a corresponding physical block. Host logical block addresses (LBAs) are assigned to laSSD LBAs (SLBAs), which identify the virtual super blocks used for striping across physical super blocks.

### CROSS REFERENCE TO RELATED APPLICATIONS

This application is a continuation of U.S. patent application Ser. No. 14/679,823, filed on Apr. 6, 2015, by Nemazie et al., and entitled “A STORAGE SYSTEM CONTROLLING ADDRESSING OF SOLID STORAGE DISKS (SSD)”, which claims priority to U.S. Provisional Application No. 62/064,845, filed on Oct. 16, 2014, by Nemazie et al., and entitled “STORAGE SYSTEM EMPLOYING SOLID STATE DISKS WITH BOUNDED LATENCY”, and is continuation-in-part of U.S. patent application Ser. No. 14/678,777, filed on Apr. 3, 2015, by Nemazie et al., and entitled “STORAGE SYSTEM REDUNDANT ARRAY OF SOLID STATE DISK ARRAY”, which is a continuation in part of U.S. patent application Ser. No. 14/073,669, filed on Nov. 6, 2013, by Mehdi Asnaashari, and entitled “STORAGE PROCESSOR MANAGING SOLID STATE DISK ARRAY”, and a continuation in part of U.S. patent application Ser. No. 14/629,404, filed on Feb. 23, 2015, by Mehdi Asnaashari, and entitled “STORAGE PROCESSOR MANAGING NAME LOGICALLY ADDRESSED SOLID STATE DISK ARRAY”, and a continuation in part of U.S. patent application Ser. No. 13/858,875, filed on Apr. 8, 2013, by Siamack Nemazie, and entitled “Storage System Employing MRAM and Redundant Array of Solid State Disk”, and is a continuation-in-part of U.S. patent application Ser. No. 14/595,170, filed on Jan. 12, 2015, by Nemazie et al., and entitled “STORAGE PROCESSOR MANAGING SOLID STATE DISK ARRAY”, which is a continuation of U.S. patent application Ser. No. 14/040,280, filed on Sep. 27, 2013, by Mehdi Asnaashari, and entitled “STORAGE PROCESSOR MANAGING SOLID STATE DISK ARRAY”.

### BACKGROUND

Achieving high and/or consistent performance in systems such as computer servers (or servers in general) or storage servers (also known as “storage appliances”) that have one or more logically-addressed SSDs (laSSDs) has been a challenge. LaSSDs perform table management, such as for logical-to-physical mapping and other types of management, in addition to garbage collection independently of a storage processor in the storage appliance.

It is a well-known problem that when data is striped across one or more laSSDs, with each laSSD including an array of flash dies, if the stripes are not consistently aligned with flash pages and block boundaries, high performance is not achieved. Since the assignment of the logical addresses to physical addresses is performed by the laSSDs independently of the storage processor, such an assignment is not guaranteed to be aligned. Hence, an optimal and consistent performance is not reached.

### SUMMARY OF THE INVENTION

Briefly, flash geometry information of the solid state disk (SS) is maintained as is a logically-addressable SSD (laSSD) geometry information of the SSD. Based on the flash geometry and the laSSD geometry, virtual super blocks are configured by dynamically binding logical SSD logical block addresses (SLBAs) of a virtual super block with a physical super block within the laSSD. A virtual super block is made of a number of virtual blocks and each virtual block made of a number of virtual pages. Each of the virtual blocks corresponds to a physical block of a physical super block within the laSSD such that the virtual pages of the virtual block correspond to like physical pages of a corresponding physical block. Host logical block addresses (LBAs) are assigned to laSSD LBAs (SLBAs), which identify the virtual super blocks used for striping across physical super blocks.

These and other objects and advantages of the invention will no doubt become apparent to those skilled in the art after having read the following detailed description of the various embodiments illustrated in the several figures of the drawing.

### IN THE DRAWINGS

FIG. 1 shows a storage system (or “appliance”), in block diagram form, in accordance with an embodiment of the invention.

FIG. 2A shows, in block diagram form, further details of the CPU subsystem 14, in accordance with an embodiment of the invention.

FIG. 2B shows, in block diagram form, further details of management blocks

FIG. 3 shows, in block diagram form, further details of the laSSD 28 of FIGS. 1 and 2.

FIG. 4 shows, in block diagram form, further details of the module controller 302, in accordance with an embodiment of the invention.

FIG. 5 shows a flow chart of the steps performed by the storage processor 10 of FIGS. 1 and 2 in assigning host-provided logical block addresses (LBAs) to SSD LBAs (LBAs associated with the SSDs 28) using geometry information collected from the SSDs.

FIG. 6 shows a flow chart of the relevant steps performed by the storage processor 10 during garbage collection (“GC”). At step 402, the process begins.

FIG. 7 shows an illustrative embodiment of the correspondence between a virtual super block and a physical super block.

FIG. 8 shows an illustrative embodiment of a configuration of the flash subsystem 304, in accordance with an embodiment of the invention.

FIGS. 9A-9B show illustrative embodiments of configurations of the flash subsystem, in accordance with embodiments of the invention.

FIGS. 10A-10C show Tables 1-3, respectively.

### DETAILED DESCRIPTION OF THE EMBODIMENTS

In the following description of the embodiments, reference is made to the accompanying drawings that form a part hereof, and in which is shown by way of illustration of the specific embodiments in which the invention may be practiced. It is to be understood that other embodiments may be utilized because structural changes may be made without departing from the scope of the present invention. It should be noted that the figures discussed herein are not drawn to scale and thicknesses of lines are not indicative of actual sizes.

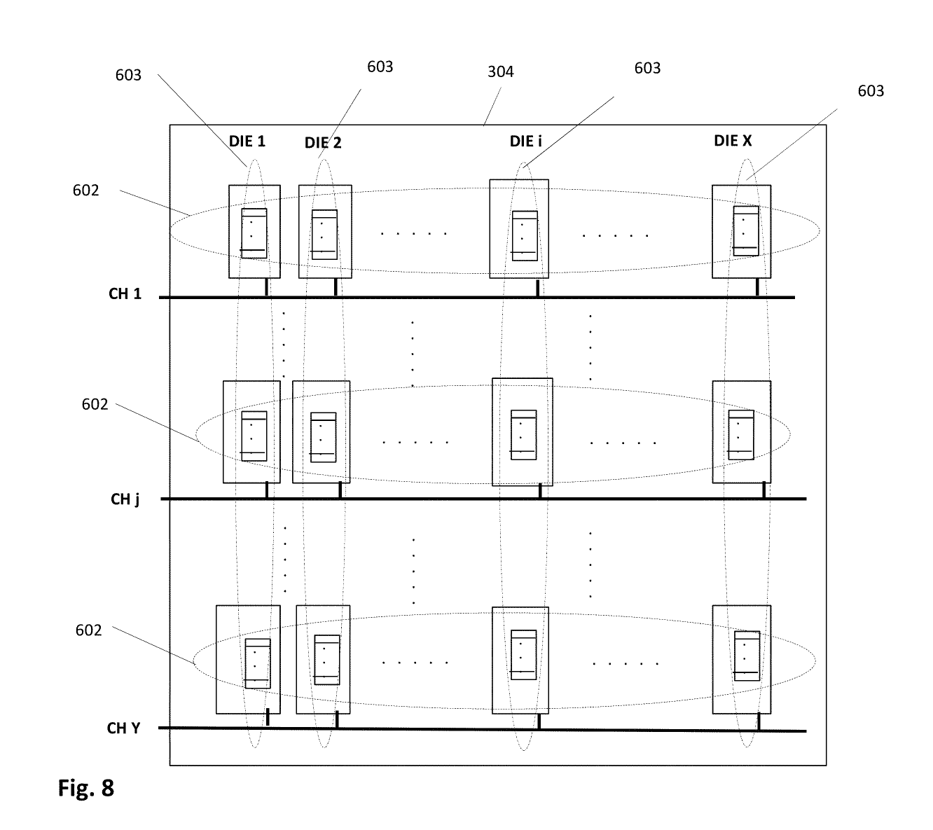

In accordance with an embodiment and method of the invention, a storage system includes one or more logically-addressable solid state disks (laSSDs), with a laSSD including at a minimum, a SSD module controller and flash subsystem. The flash subsystem has an array of flash dies (or “dies”). Each flash die includes an array of flash memory cells, such as NAND flash organized in blocks. Forming die groups from flash dies within the flash sub-system, each flash die belongs to a die group. In one embodiment the die groups are RAID groups within laSSD. Forming physical super blocks within die groups, super block including a block from each die within group. In another embodiment the blocks are in like position in dies within die group. FIG. 8 which will be discussed later shows an illustrative embodiment of a configuration of the flash subsystem 304, in accordance with an embodiment of the invention. The flash subsystem 304 is shown to include Y number of channels and X number of dies per channel, “X” and “Y” being an integer. Each of the dies 1-X is coupled to a distinct channel. For example, dies 1-X of the top row of flash subsystem 304 are all shown coupled to the channel, CH 1, and each of the dies 1-X of a next row are all shown coupled to the channel, CH j, and so on. A (physical) super block 603 may be flexibly formed of a row of dies 1-X or of a column of channels, CH 1 through CH Y, with a die, of dies 1-X, included in the super block.

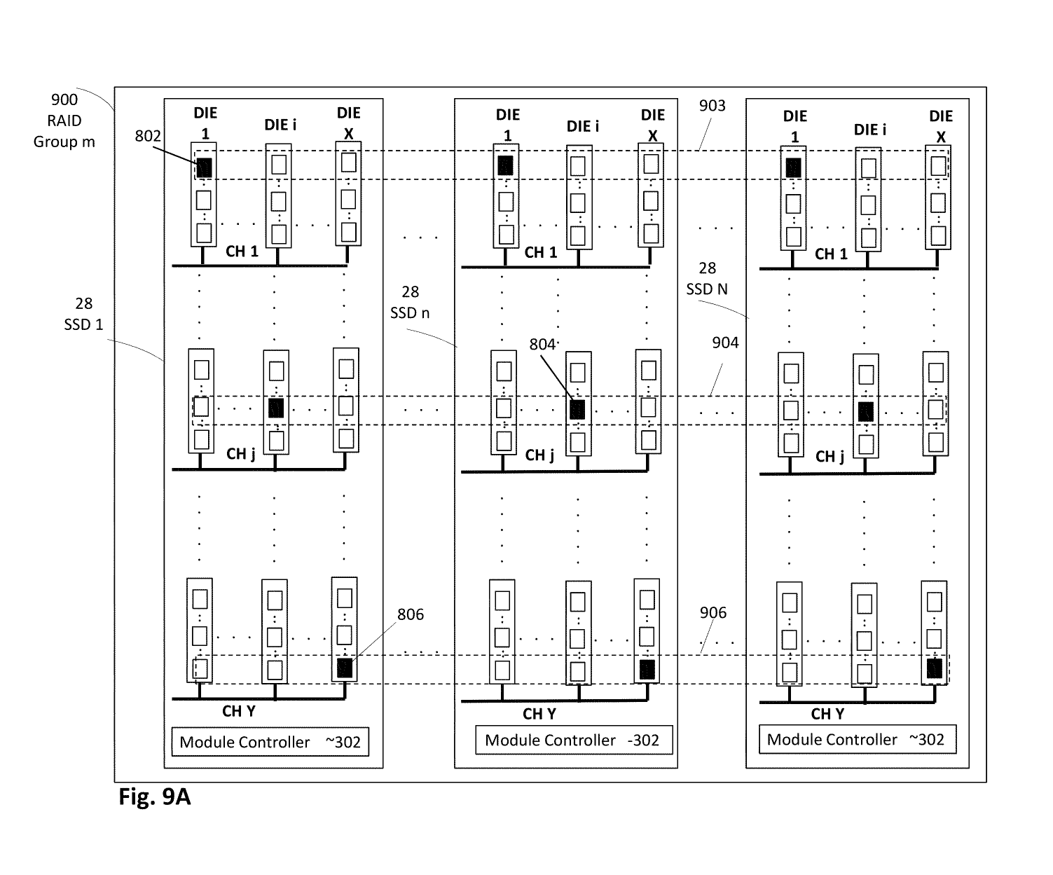

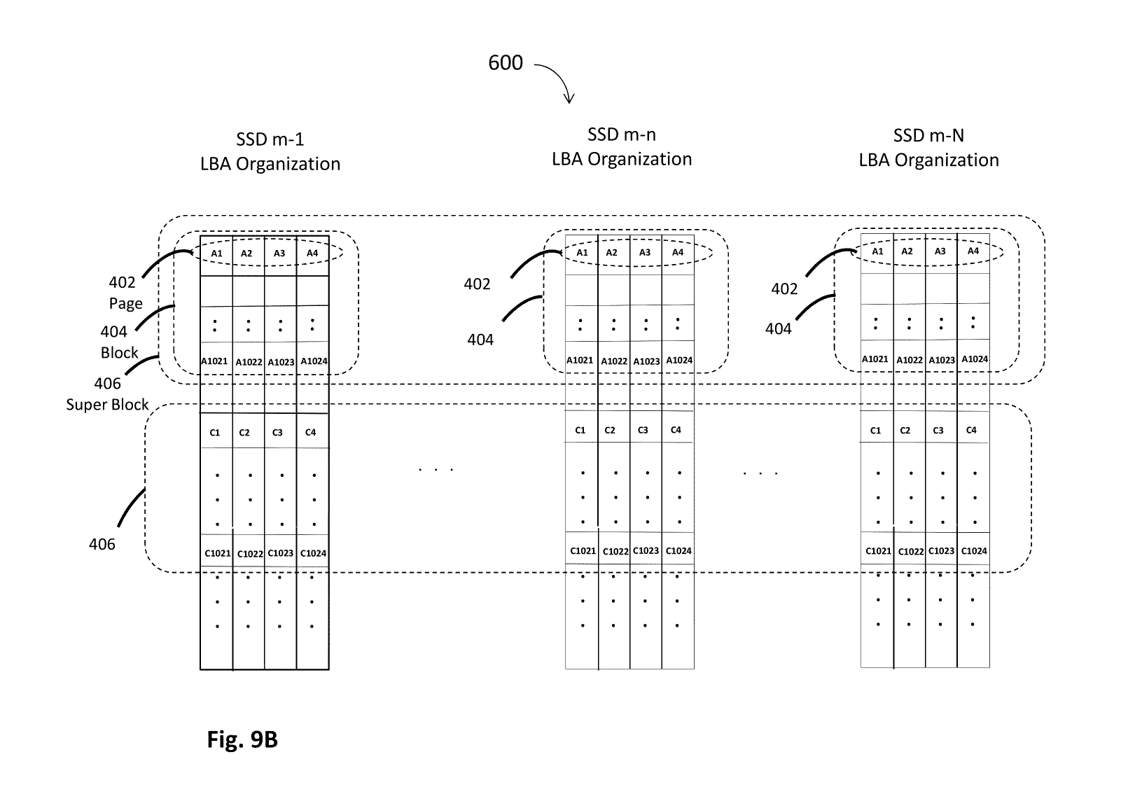

Similarly SSD groups can be formed from a group of laSSDs, die groups are formed from flash dies of a SSD group (for example one die from each laSSD of the SSD group) and super blocks are formed including a block from each die within the die group. Super blocks can be formed within or across laSSDs or a combination (a combination also referred to as two dimensional super block, is a group of super blocks across laSSDs). SSD groups in the storage system are enumerated and assigned a SSD group number; from 1 to M, where M is the number of groups. Die groups in the storage system are enumerated and assigned a die group number (DGN), from 1 to DG, where DG is the number of die groups in the storage system. It is understood that the various methods and embodiments of the invention apply to known standards, such as without limitation, RAID 5 and RAID 6 SSDs. FIG. 9A which will be discussed later shows an illustrative embodiment of forming super blocks across a group of laSSDs, in accordance with an embodiment of the invention. More specifically three distinct SSDs, i.e. SSD 1, SSD n and SSD N, of a RAID group comprising N SSDs are shown, which collectively, make up a RAID group, i.e. RAID group m 900. Further shown in FIG. 9A are exemplary RAID super block 903, 904 and 906. Each of these RAID super blocks is shown made of a block of one die per SSD. For example, RAID stripe 903 is shown formed of a block in die 1 802 of the SSD 1, a block die 1 of SSD n, and a block of die 1 of SSD N.

As used herein, the term “channel” is interchangeable with the term “flash channel” and “flash bus”. As used herein, a “segment” refers to a chunk of data in the flash subsystem of the laSSD that, in an exemplary embodiment, may be made of one or more pages. However, it is understood that other embodiments are contemplated, such as without limitation, one or more blocks and others known to those in the art.

The term “block” as used herein, refers to an erasable unit of data. That is, data that is erased as a unit defines a “block”. In some patent documents and the industry, a “block” refers to a unit of data being transferred to, or received from, a host, as used herein, this type of block may be referenced as “data block”. A “page” as used herein, refers to data that is written as a unit. Data that is written as a unit is herein referred to as “write data unit”. A “dual-page” as used herein, refers to a specific unit of two pages being programed/read, as known in the industry. A “stripe” as used herein, refers to pages that are in like-locations in a super block within one or more SSDs but that the associated blocks can, but need not be, in like-locations across the flash subsystem of one or more SSDs.

Embodiment and methods of the invention reduce processing by laSSD for garbage collection. Another object of invention is to provide a method for performing garbage collection by the storage processor (or processor), and allow for a software-defined garbage collection by the use of virtual super blocks.

Briefly, in accordance with an embodiment of the invention, a storage appliance includes one or more laSSDs, the laSSDs including a module controller and flash subsystem, the flash subsystem comprising an array of flash dies; herein after an array. The laSSDs are capable of communicating their flash and SSD geometry information to the storage processor. Various embodiments of invention are disclosed to create and bind a group of SSD LBAs (SLBAs) to a virtual block that is further used to create a super block across a group of laSSDs or within a laSSD or a combination, the storage processor can perform the striping across a virtual superblock enabling consistent performance The storage processor performs logical garbage collection at a block or super block level, subsequently the storage processor issues a command such as SCSI TRIM command to the laSSDs invalidating the SLBAs in the groups, and in response the laSSD will perform the erase operation immediately after the TRIM command. Virtual blocks and virtual super blocks are dynamic, after TRIM command (explained below) they are deleted (removed) and the storage processor may create them again

While in prior art systems, the manner in which data is striped within the laSSDs is not defined by the storage processor, it is in accordance with various embodiments and methods of the invention. Using the storage processor to define striping allows for consistent performance. Additionally, software-defined striping provides for higher performance.

While in prior art systems the algorithm used for garbage collection is not defined by storage processor and furthermore garbage collection requires considerable processing by laSSD, it is in accordance with various embodiments and methods of the invention. With any of the embodiments, the storage processor manages or is aware of flash and laSSD geometry and the group of SLBAs that are mapped to physical blocks in laSSD, the latter provides a software-defined framework for data striping and garbage collection. Additionally in the laSSD of the present invention the complexity of mapping table and garbage collection within laSSD is significantly reduces compared with prior art lsSSDs

These and other advantages are of the embodiments the invention are described below in detail.

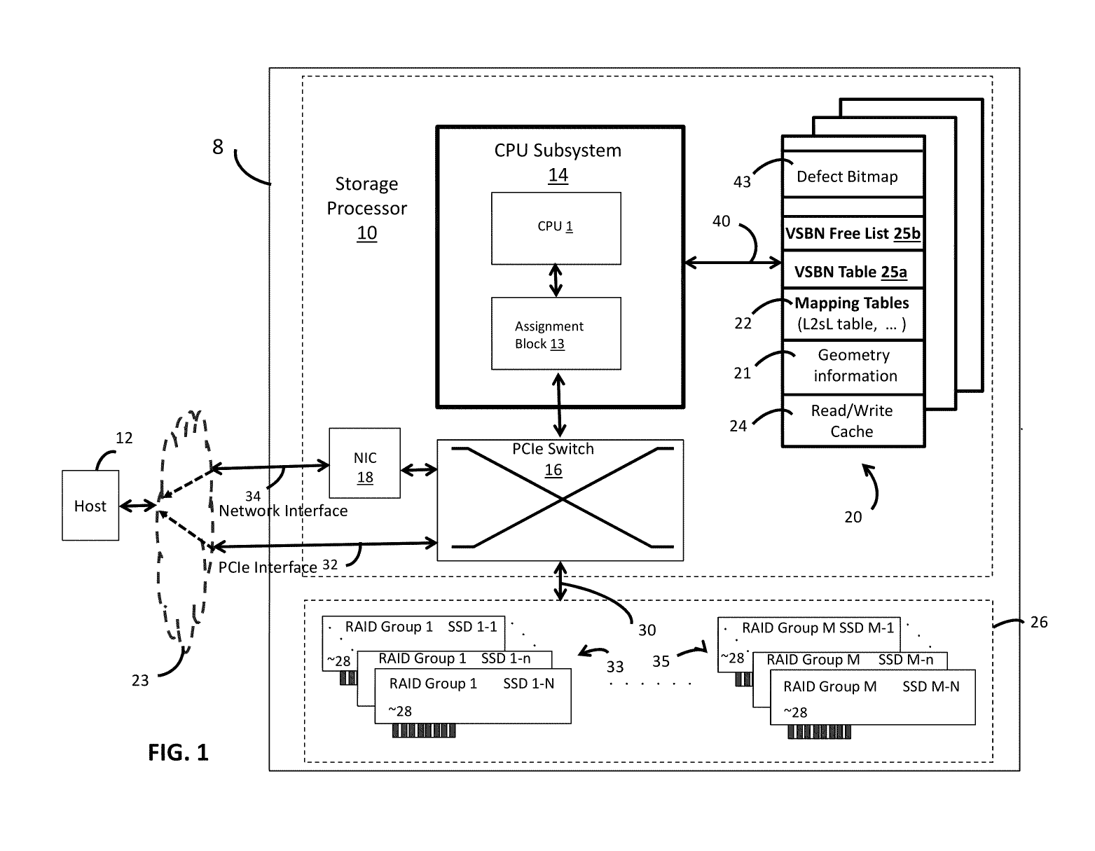

Referring now to FIG. 1, a storage system (or “appliance”) 8 is shown, in block diagram form, in accordance with an embodiment of the invention.

The storage system 8 is shown to include storage processor 10 and a storage pool 26 that are communicatively coupled together.

The storage pool 26 is shown to include banks of solid state drives (SSDs) 28, understanding that the storage pool 26 may have additional SSDs than that which is shown in the embodiment of FIG. 1. A number of SSD groups configured as RAID groups, such as RAID group 1, is shown to include SSD 1-1 through SSD 1-N (‘N’ being an integer value), while the RAID group M (‘M’ being an integer value) is shown made of SSDs M-1 through M-N.). In an embodiment of the invention, the storage pool 26 of the storage system 8 is a Peripheral Component Interconnect Express (PCIe) solid state disks (SSD), herein thereafter referred to as “PCIe SSD”, because it conforms to the PCIe standard, adopted by the industry at large. Industry-standard storage protocols defining a PCIe bus, include non-volatile memory express (NVMe).

The storage system 8 is shown coupled to a host 12 either directly or through a network 23. The storage processor 10 is shown to include a CPU subsystem 14, a PCIe switch 16, a network interface card (NIC) 18, and memory 20. The memory 20 is shown to include mapping tables (or “tables”) 22, defect bitmap 43, a geometry information 21 and a read/write cache 24. The storage processor 10 is further shown to include an interface 34 and an interface 32. The CPU subsystem 14 includes a CPU 1. The CPU 1, which may be a multi-core CPU, is the brain of the CPU subsystem and as will be shortly evident, performs processes or steps in carrying out some of the functions of the various embodiments of the invention. The CPU subsystem 14 and the storage pool 26 are shown coupled together through PCIe switch 16 via bus 30. The CPU subsystem 14 and the memory 20 are coupled together through a memory bus 40.

The memory 20 is shown to include information utilized by the CPU 14, such as mapping tables 22, defect bitmap 43, geometry information 21 and read/write cache 24. It is understood that the memory 20 may, and typically does, store additional information, not depicted in FIG. 1.

The memory 20 can be located externally or internally to the CPU subsystem 14.

The host 12 is shown coupled to the NIC 18 through the network interface 34 and is optionally coupled to the PCIe switch 16 through the PCIe interface 32. In an embodiment of the invention, the interfaces 34 and 32 are indirectly coupled to the host 12, through the network 23. An example of a network is the internet (world wide web) or Ethernet local-area network or a fiber channel storage-area network.

The NIC 18 is shown coupled to the network interface 34 for communicating with host 12 (generally located externally to the processor 10) and to the CPU subsystem 14, through the PCIe switch 16.

Geometry

The laSSDs are capable of communicating its flash and SSD geometry information to the storage processor. Flash geometry information is information about the type of flash and characteristics of the flash, such as number of available blocks per die, number of pages per block, flash page size, flash modes (single page or dual page). The SSD geometry information (also referred to herein as “laSSD geometry information”) includes information such as arrays size (number of channels, and number of dies per channel).

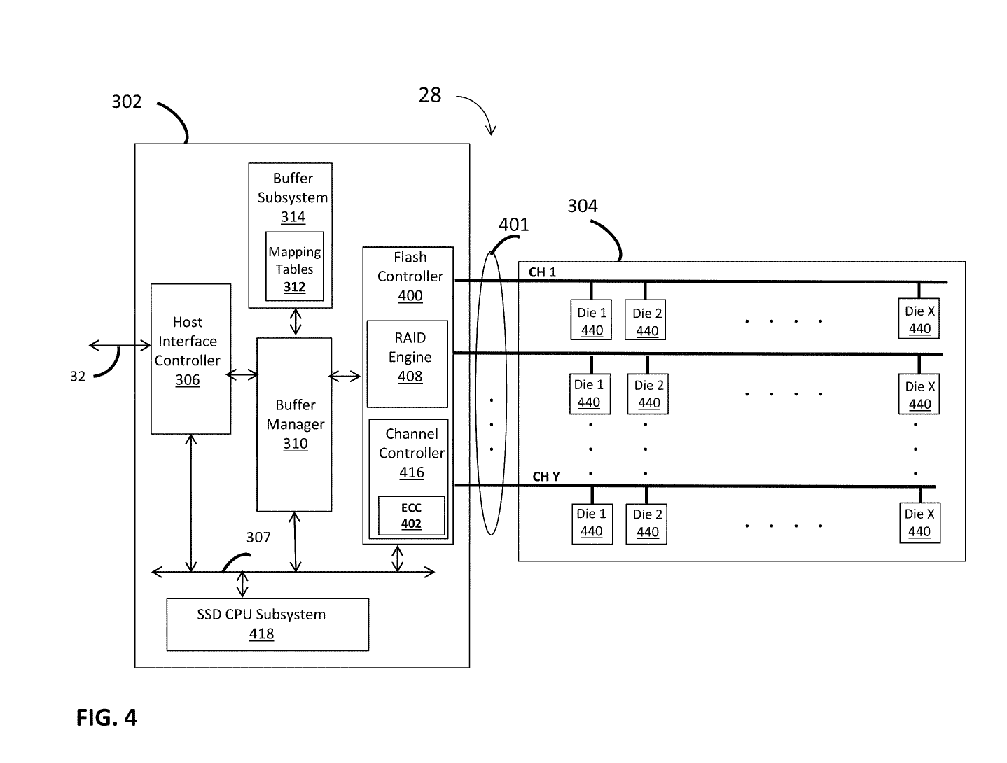

Geometry information 21 includes flash geometry and laSSD geometry information. Flash geometry information includes storage configuration information, examples of which are page size, block size, and the number of blocks in a flash die. laSSD geometry information includes SSD configuration information, such as the number of dies per channel and the number of channels of the SSD. Referring to the embodiment shown in FIG. 4, the number of dies per channel is ‘X’ and the number of channels is ‘Y’. ‘X’ and ‘Y’ each representing an integer value.

Virtual Super Blocks (VSB)

In an embodiment of the invention, binding is initiated by the storage processor 10. In accordance with an embodiment and method of the invention, the storage processor issues a command to the laSSD when initiating binding. An example of such a command is the vendor unique command, readily known to those in the industry. Other means of initiating binding are contemplated.

Prior to binding taking place, the storage processor 10 provides to a laSSD, a virtual block number, identifying a virtual block; a group of SLBAs associated with the virtual block; a channel number; and a die number, the latter two of which collectively identify a specific die. The storage processor may provide all of the foregoing to the laSSD using one or more commands.

In an exemplary embodiment and method of the invention, the storage processor employs more than a single vendor unique command. One vendor unique command is used to create a virtual block that is ultimately bound to a flash block in the specific die of the laSSD, and one or more additional vendor unique commands are used to assign the group of SLBAs from the storage processor to the virtual block. That is, one or more additional vendor unique commands are issued to the laSSD for binding prior to issuing commands other than those relating to binding.

The group of SLBAs from the storage processor 10 is provided generally by specifying a SLBA start address and a count of SLBAs, which together define a sequential range of SLBAs. It is noted that other ways of specifying a group of SLBAs falls within the spirit and scope of the invention. Typically, the size of the range of SLBAs is in multiples of the size of virtual pages.

In yet another embodiment and method of the invention, a vendor unique command is used by the storage processor 10 to create a virtual block but the assignment of SLBA group to the virtual block is performed by the laSSD later during each subsequent write operation in the same manner as discussed above, i.e. using a SLBA start address and a count of SLBAs in the group. This method avoids sending a list of SLBA ranges in a separate command such as the above-noted embodiment.

Upon receiving the information provided by the storage processor 10, the laSSD, binds the virtual block to a flash block in the specific die and sequentially assigns the group of SLBAs associated with the virtual block to pages in the flash block. In one embodiment of the invention, the flash block is identified by a flash block number with the flash block number generated by the laSSD and based on the availability of the flash blocks. That is, only unassigned flash blocks within the specific die are candidates for the binding operation that the laSSD is to perform. Unassigned flash blocks are flash blocks not currently bound. In the event no such unassigned flash block exists in the specific die, binding is not successful. Binding to an unassigned and defect-free flash block is considered successful.

Alternatively, flash block numbers are generated by the storage processor 10.

Upon successfully performing the binding operation, the laSSD notifies the storage processor 10 of the same. In an exemplary embodiment and method of the invention, the laSSD does so by returning a ‘pass’ or ‘fail’ indication to the storage processor.

Any of the embodiments and methods of the invention can also be employed to create a virtual super block that spans a group of laSSD or is comprised entirely within a single laSSD, or a combination thereof. A virtual super block is identified by a virtual super block number (VSBN), thus, all virtual blocks of a virtual super block are associated with a common virtual super block number. It is understood that the discussions and illustrations herein present merely one of a myriad of other methods and embodiments for creating virtual super blocks, all of which are contemplated.

Therefore, a virtual super block, identified by a virtual super block number, is associated with a specific die group and a block-sized group of SLBAs of each die in the die group and bound to flash blocks.

Table 1 below shows a table indexed by VSBNs of die groups and SLBA groups associated with the VSBNs. For the purpose of reducing the size of the table, die group numbers are used in Table 1 instead of a list of dies associated with a die group, such as that shown by Table 2.

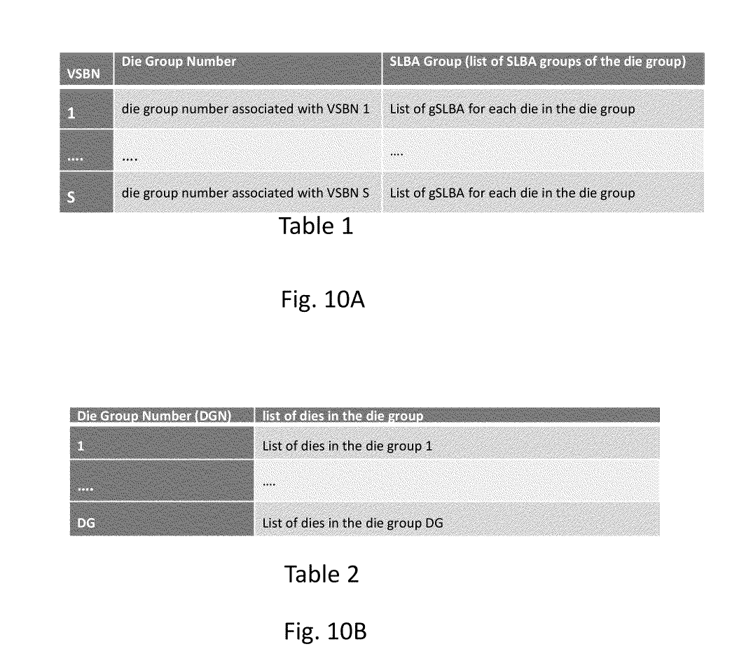

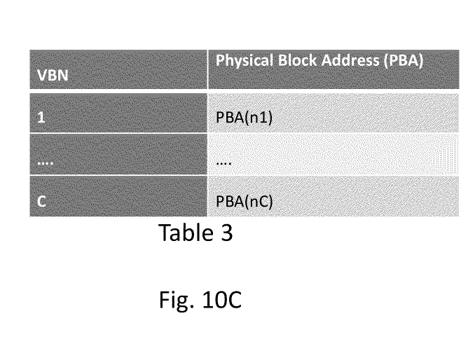

Referring now to FIG. 10A, in Table 1, which shows a VSB table structure, ‘S’ represents the number of VSBNs in the storage pool 26, where ‘S’ is an integer

As mentioned before die groups in the storage system are enumerated and assigned a die group number (DGN), from 1 to DG, where DG is the number of die groups in the storage pool 26 where ‘DG’ is an integer. The general structure of a die group table is shown in Table 2 of FIG. 10B where the DGN is the index of the table.

The embodiments shown and discussed thus far are general schemes for representing a VSB. Alternatively, there are ways to reduce memory space required for tables that include VSBs.

In an exemplary embodiment of the invention, the above-noted table is replaced by calculation VSBNs and associated block-sized SLBA ranges. To this end, a group of SLBAs, which is bound to a virtual block (with a virtual block number VBN) has a SLBA range with a size that is the same as the size of a block. For the purpose of the example to follow, let ‘C’ represent the expected number of block-sized SLBA ranges in a laSSD, and ‘B’ represent the expected number of block-sized SLBA ranges in a flash die of a laSSD (assuming there are B block-sized SLBA ranges in a die), and ‘D’ represent the number of dies in laSSD, and ‘M’ represent the number of laSSD groups in storage pool 26.

The block-sized SLBA ranges 1 through C are partitioned among the dies in the laSSD. In one such partition, block-sized SLBA range 1 through B is assigned to die 1 in laSSD group 1. Block-sized SLBA range B+1 through 2B is assigned to die 2 in laSSD group 1, block-sized SLBA range DN*B+1 to (DN+1)*B is assigned to die DN in laSSD group 1, and so forth. Stated differently, block-sized SLBA range m*DN*B+k is assigned to die DN in laSSD group m, where k is an integer ranging from 1 through B. Other types of partitions fall within the spirit of the invention. The VBN associated with a block-sized SLBA range m*DN*B+k in die number DN of laSSD group m is m*DN*B+k, where k is an integer ranging from 1 through B.

Virtual super blocks across a group of laSSDs have associated dies that are in like positions and SLBA ranges that are like in position. Therefore, the die group list of Tables 1 and 2 is reduced to a laSSD group number (m) and a die number (DN) and the SLBA group list and VSBN (virtual blocks of a virtual super block are assigned the same virtual super block number; VSBN) are reduced to m*DN*B+k where ‘k’ is an integer ranging from 1 through B. Thus, in the above approach, the need for a table is eliminated.

In situations where the number of non-defective blocks is less than ‘B’, certain block-sized SLBA ranges are skipped. For example, die number DN in laSSD group m may have B′ good blocks where B′<B. In this example, the block-sized SLAB ranges m*B*DN+k for k>B′ are skipped and not used.

In accordance with various embodiments of the invention, the storage processor 10 assigns groups of SLBAs to pages of blocks within the storage pool 26 where the blocks are identified by a virtual block number. This is done without regard to the host LBAs. Once the grouping and assignment is determined, the host LBAs are assigned to these SLBAs. These SLBAs effectively identify locations within which data from the host 12 is to be stored. The storage processor 10 is therefore ignorant of exactly which pages or blocks the data is stored in and is rather only knowledgeable about the groupings of the pages or blocks, as identified by the SLBAs and VBN. The foregoing allows the storage processor to control not only which laSSDs the host data is ultimately stored in but also like locations of units within which the data is stored in the laSSDs, the units being either pages or blocks. In this manner, the storage processor 10 controls striping across the laSSDs of the storage pool 26.

In some embodiments of the embodiment, the grouping of the SLBAs may be random in order but would require a table to maintain the grouping information. An example of such a table is Table 1 of FIG. 10A. In some other embodiments, no table is needed but there is structure to the grouping. An intermediate embodiment uses a table whose size depends on the structuring of the groupings, i.e., the more structure, the smaller the table size.

Control by the storage processor 10 increases performance of the overall system, i.e. storage system 10, storage pool 26 and host 12. Performance improvement is realized over that of prior art systems because the storage system 10 has a global view of data traffic of the overall system and is further aware of what is going on with the overall system as opposed to the SSDs of the storage pool 26, which have comparatively limited view.

In accordance with a method and apparatus of the invention, an exemplary manner in which the storage system 10 is capable of controlling addressing of the SSDs of the storage pool 26 is by maintaining geometry information of the SSDs in its memory 20 and further maintaining virtual super blocks associated with the SSDs. The virtual super blocks are identified by SLBAs. Based on the flash geometry information, the CPU subsystem 14 of the storage system 10 dynamically binds the SLBAs of the virtual super blocks to physical super blocks. The bound SLBAs identify locations of the physical super blocks. Physical super blocks are made of physical blocks with each physical block having a physical pages. Similarly, virtual super blocks are each made of virtual blocks with each virtual block having virtual pages. Each of the virtual blocks corresponds to a physical block of a physical super block such that each of the virtual pages of the virtual block correspond to like physical pages of a physical block within the SSDs of the storage pool 26. At least some of the super physical blocks or at least some of the super virtual blocks span more than one SSD, therefore, the CPU subsystem can and does assign the host LBAs received from the host 12 to the bound SLBAs and accordingly stripes across the physical super blocks while also causing striping across corresponding virtual super blocks.

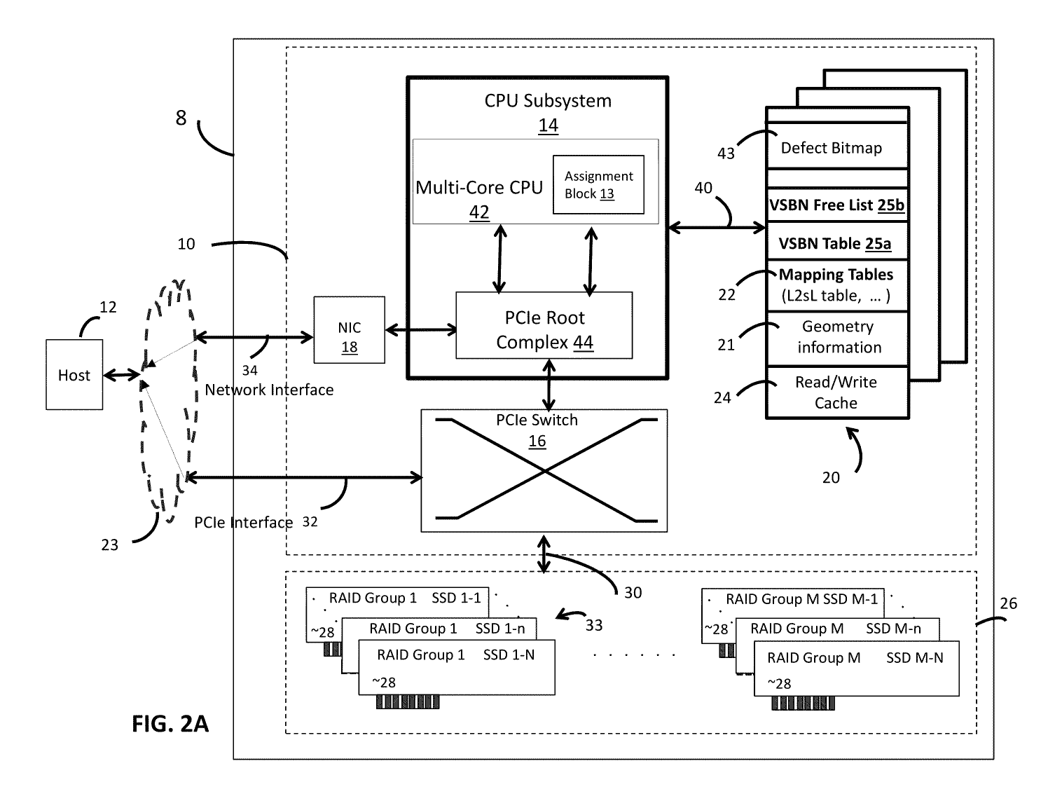

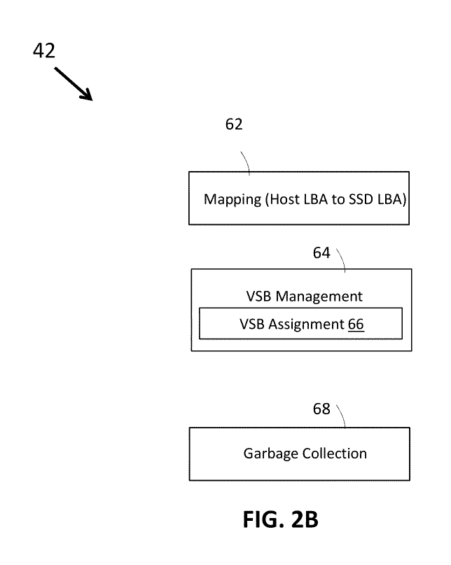

Referring now to FIG. 2A, a number of functions performed by the CPU 42 are shown in block form. Namely, mapping 62, VSB management 64 and garbage collection 68 operations, performed by the CPU 42 are shown. Alternatively, other ways of implementing the foregoing functions may be employed, such as by hardware.

Mapping 62

During the mapping process, host LBAs are assigned to SLBAs and this association is stored in the L2sL table, i.e. in mapping tables 22 of memory 20.

VSB Management 64

The CPU 42 keeps track of free (unassigned) virtual super block numbers and associated SLBA ranges. The CPU 42 keeps track of free virtual super block numbers by means of a VSBN liked list 25, which lists only available (or “free”) VSBNs. It is understood that numerous other apparatus and methods are available that are too numerous to list here but that are readily known to one skilled in the art and all fall within the scope of the invention.

Based on the foregoing geometries, virtual super blocks are configured by the CPU 42 by dynamically binding a group of SLBAs (associated with virtual blocks of a virtual super block) to a physical super block.

Virtual blocks are dynamic, and after a TRIM command is issued (explained below), they are deleted (removed) and may be created again.

The CPU 42 keeps track of free (unassigned) virtual super block numbers. The CPU 42 keeps track of free virtual super block number by employing the free VSBN linked list 25.There are numerous other means available for doing so, which are readily known to those skilled in the art and all fall within the scope of the invention.

A virtual super block has a number of virtual blocks with each virtual block having a number of virtual pages. Each of the virtual blocks correspond to a physical block of a physical super block such that the virtual pages of the virtual block correspond to like physical pages of a corresponding physical block. The result of the binding is stored in VSBN table 25a of the memory 20. As noted above, in an embodiment of the invention, there is no need for VSBN table 25a.

Garbage Collection

The CPU 42 also performs logical garbage collection at a block or super block level. Logical garbage collection uses the binding of SLBAs to physical blocks in laSSDs, as discussed above for moving valid SLBAs. The CPU 42 avoids overwrite of a location with the laSSDs that is identified by an assigned SLBA until the completion of logical garbage collection of associated blocks. LBA updates are assigned to free (unassigned) SLBAs. The CPU 42 tracks SLBAs that are no longer valid and have to be eventually garbage collected.

In one embodiment, the CPU 42 picks SLBA or super groups with the most number of invalid SLBAs as candidates for logical garbage collection. Logical garbage collection includes moving all valid host LBAs from associated SLBA groups being logically garbage collected to other SLBA groups until there are no more valid SLBAs within the SLBA groups. Subsequently, the CPU 42 issues a command, such as SCSI TRIM command, to the laSSDs to invalidate the SLBA groups. The laSSDs, while performing physical garbage collection, detect that all the pages within the blocks are invalid and hence do not have to be moved before erasing.

The TRIM command may have various alternate embodiments. In one embodiment of the invention, the laSSDs will only perform erase operation during garbage collection after receiving the TRIM command. In yet another embodiment, the laSSDs will perform an erase operation immediately after receiving the TRIM command. In yet another embodiment, the laSSDs do not acknowledge completion of the TRIM command until the erase operation is completed and this manner, the completion of the TRIM command necessarily takes place after completion of the erase operation. Accordingly, behavior of the laSSD is predictable to the CPU 42.

In another embodiment of the invention, the CPU 42 ensures that only one TRIM command in a RAID group is outstanding to allow reconstructing of read operations received for a common die, i.e. the die that is busy with an erase operation. For further information regarding reconstruction of read operations, the reader is directed to U.S. Patent Application No. 62/064,845, filed on Oct. 16, 2014, by Nemazie et al., and entitled “STORAGE SYSTEM EMPLOYING SOLID STATE DISKS WITH BOUNDED LATENCY”.

In an embodiment of the invention, parts or all of the memory 20 are volatile, such as without limitation, dynamic random access memory (DRAM). In other embodiments, part or all of the memory 20 is non-volatile, such as and without limitation, flash, magnetic random access memory (MRAM), spin transfer torque magnetic random access memory (STTMRAM), resistive random access memory (RRAM), or phase change memory (PCM). In still other embodiments, the memory 20 is made of both volatile and non-volatile memory, such as DRAM on Dual In Line Module (DIMM) and non-volatile memory on DIMM (NVDIMM), and memory bus 40 is the a DIM interface. The memory 20 is shown to save information utilized by the CPU 14, such as mapping tables 22, defect bitmap 43, geometry information 21 and read/write cache 24. Mapping tables 22 include a logical to SSD logical (L2sL) table, VSBN table 25a and VSBN free list 25, read/write cache 24 are caches that are utilized by the CPU 14 during reading and writing operations for fast access to information.

In one embodiment, the read/write cache 24 is in the non-volatile memory of the memory 20 and is used for caching write data from the host 12 until host data is written to the storage pool 26, therefore providing a consistent latency for write operations. The defect bitmap 43 maintains bitmaps of defects for the SSDs of the storage pool 26.

In embodiments where the mapping tables 22 are saved in non-volatile memory of the memory 20 and remain intact even when power is not applied to the memory 20. Maintaining information in memory at all times, including power interruptions, is of particular value because the information maintained in the tables 22 is needed for proper operation of the storage system subsequent to a power interruption.

During operation, the host 12 issues a read or a write command. Information from the host is normally transferred between the host 12 and the storage processor 10 through the interfaces 32 and/or 34. For example, information is transferred, through interface 34, between the storage processor 10 and the NIC 18. Information between the host 12 and the PCIe switch 16 is transferred using the interface 34 and under the direction of the of the CPU subsystem 14.

In the case where data is to be stored, i.e. a write operation is consummated, the CPU subsystem 14 receives the write command and accompanying data for storage, from the host, through PCIe switch 16. The received data is first written to write cache 24 and ultimately saved in the storage pool 26. The host write command typically includes a starting LBA and the number of LBAs (sector count) the host intends to write as well as a LUN. The starting LBA in combination with sector count is referred to herein as “host LBAs” or “host-provided LBAs”. The storage processor 10 or the CPU subsystem 14 maps the host-provided LBAs to portion of the storage pool 26.

In the discussions and figures herein, it is understood that the CPU subsystem 14 executes code (or “software program(s)”) to perform the various tasks discussed. It is contemplated that the same may be done using dedicated hardware or other hardware and/or software-related means.

The storage system 8 suitable for various applications, such as without limitation, network attached storage (NAS) or storage attached network (SAN) applications that support many logical unit numbers (LUNs) associated with various users. The users initially create LUNs with different sizes and portions of the storage pool 26 are allocated to each of the LUNs.

In an embodiment of the invention, as further discussed below, the table 22 maintains the mapping of host LBAs to SSD LBAs (SLBAs).

During the operation of storage system, the assignment of the host LBAs to SLBAs, by the storage processor 10, is effectively the assignment of host-provided LBAs to SLBAs where the SLBAs identify virtual super blocks. Thus, when the CPU sub-system 14 writes to a virtual block of a virtual super block, automatically writing to a corresponding physical block of a corresponding bound physical super block is performed. It is desirable to ultimately have a sequence of SLBAs to end up in the same physical block of a SSD.

In accordance with a method of the invention, managing SSDs includes garbage collection for a virtual super block. After relocation of valid SLBAs in a virtual super block to another virtual super block, the physical super block associated with the virtual super block is reclaimed by sending one or more TRIM commands to the SSDs. “Invalid” LBAs identify locations maintaining information that is outdated whereas valid SLBAs identify locations that maintain current or up-to-date information. After each garbage collection, the L2sL table of the table 22 is updated.

In managing one or more SSDs, in accordance with a method of the invention, SLBAs are bound (or “assigned”) to a physical super block such that the SLBAs are striped across the physical super block before starting striping across another physical super block. During garbage collection, after relocation of valid SLBAs of a virtual super block to another virtual super block, the physical super block associated with the virtual super block is reclaimed by sending one or more TRIM commands to the SSD.

FIG. 2B shows, in block diagram form, further details of the CPU subsystem 14, in accordance with an embodiment of the invention. The CPU subsystem 14's CPU is shown to be a multi-core CPU 12 and the CPU subsystem 14 is shown to include a PCIe root complex block 44. Among its functions, the block 44 determines the number of lanes based on the configuration of the switch 16. It connects the CPU 12 and storage pool 26 to the switch 16. The switch 16 may include one or more switch devices.

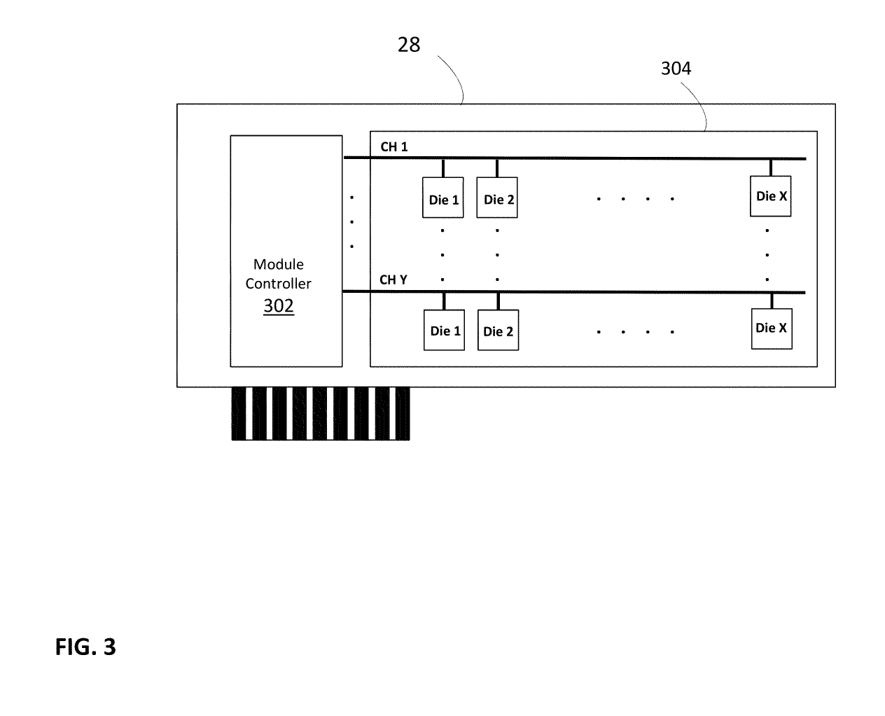

FIG. 3 shows, in block diagram form, further details of the laSSD 28 of FIGS. 1 and 2. The laSSD 28 is shown to have a SSD module controller 302 and a flash subsystem 304, in accordance with an embodiment of the invention. The module controller 302 receives and sends info nation through the bus 30 from the PCIe switch 16 (shown in FIGS. 1 and 2) and is coupled to the flash subsystem 304, which is generally the storage space (flash memory) of the laSSD 28.

Under the control of the module controller 302, information is stored in and read from the flash subsystem 304. Additionally, the module controller 302 erases blocks in flash memory of the flash subsystem 304,

FIG. 4 shows, in block diagram form, further details of the module controller 302, in accordance with an embodiment of the invention. The module controller 302 is shown to include a buffer subsystem 314, a buffer manager 310, a host interface controller 306, SSD CPU subsystem 418, and a flash controller 400, in accordance with an embodiment of the invention. The CPU subsystem 418 is shown coupled to the host interface controller 306, the buffer manager 310 and the flash controller 400, through a CPU bus 307.

The flash controller 400 is shown to include a RAID engine 408 and a channel controller 416, which is shown to include an error checking and correction (ECC) block 402. The buffer subsystem 314 is shown to include mapping tables 312, which generally maintain address translation table(s). The module controller 302 and the flash subsystem 304 are shown coupled together through flash interface 401. The flash interface 401 includes one or more flash channels (bus). An example of a flash bus is Open NAND Flash Interface (ONFI).

The module controller 302 receives from and sends information to the storage processor 10 through the host bus 32, which is shown coupled to the host interface controller 306 of the module controller. Information received by the controller 306 may include data, command, meta data, and the like, all of which are readily known to those in the art. Data received from the storage processor 10 may be referred to herein as “host data” and is intended to be saved in the flash subsystem 304, under the control of the module controller 302.

The buffer manager 310 manages communication between the CPU subsystem 418 and the controller 306, within the module controller 302. Similarly, the buffer manager 310 manages communication between the buffer subsystem 314 and the flash controller 400 and the host interface controller 306. The flash controller 400 sends and receives information to and from the flash subsystem 304, through the flash interface 401.

In an embodiment of the invention, read, write, and erase operations are performed concurrently relative to multiple channels, thereby increasing the bandwidth of the flash subsystem 304. Concurrent operations may be performed across multiple channels or across dies of a channel through the interface 401. Accordingly, by way of examples, while a die of one channel is being written to, a die of a different channel may be read from or while a die of a channel is being erased, another die of the same channel may be written to.

The RAID engine 408, which need not be within the flash controller 400, generates parity and reconstructs the information that is intended to be read from a die within an SSD, such as the SSD 28, but that is no longer reliable during read operations. The channel controller 416 controls the exchange of information between the flash subsystem 304 and the module controller 302 through the flash interface 401. The ECC block 402 performs error detection and/or correction of data that is read from the flash subsystem 304, as is typically required to be done for flash memory in this manner and as is generally known in the art, data written to the flash subsystem 304 is encoded, or appended with error correction code, and data read from the flash subsystem 304, is decoded and striped of its appended error correction code.

The CPU subsystem 418 is the brain of the module controller 302 and directs various structures within the module controller 302 to perform certain tasks. The controller 306, manager 310, subsystem 314 and controller 400 operate under the control and direction of the CPU subsystem 418. Through execution of code saved within the CPU subsystem 418, the CPU subsystem 418 manages execution of commands received through the bus 32 and directs the various structures of the module controller 302 to act accordingly. For instance, the CPU subsystem 418 initiates sending of data that is read from the flash subsystem 304 through the bus 32, during a read operation, and saving of data received through the bus 32, in the flash subsystem 304, during a write operation. Analogously, erase operations are initiated by the CPU subsystem 418. Additionally, the CPU subsystem 418 maintains (updates) the mapping tables 312 and initiates (batches of) operations to be performed by the flash controller 400.

The mapping table 312 of laSSD corresponding to embodiments of the invention is substantially smaller (orders of magnitude) than mapping table of generic laSSDs as it is based on block (unit of erase, which is in the order of mega byes) rather than data block (unit of data size to/from host 12, which is in the order of kilo bytes).

In FIG. 10C, Table 3 shows an optimized SSD table 312 structure corresponding to Table 2 and similar embodiments.

The index ‘n1’ through ‘nC’ correspond to VBN in a laSSD. The mapping table 312 of the laSSD, of the various embodiments of the invention, is block-based and substantially smaller than a mapping table of a generic laSSD.

RAID engine 408 performs RAID reconstruction of the data of a die when the data read from the die is detected to have errors or when the die is busy with a write/erase operation. To perform RAID reconstruction, the RAID engine 408 uses information from the remaining dies within a RAID stripe that includes the die within the flash subsystem 304. A parity block resides within a RAID stripe and used, along with the remaining data of the die, to reconstruct the data that has errors.

A command queue (not shown), within the flash controller 400 of FIG. 4, stores commands associated with read/program/erase operations of the flash subsystem 304. It is understood that the command queue may save commands in categories of command types, with categories including read/write/erase operations.

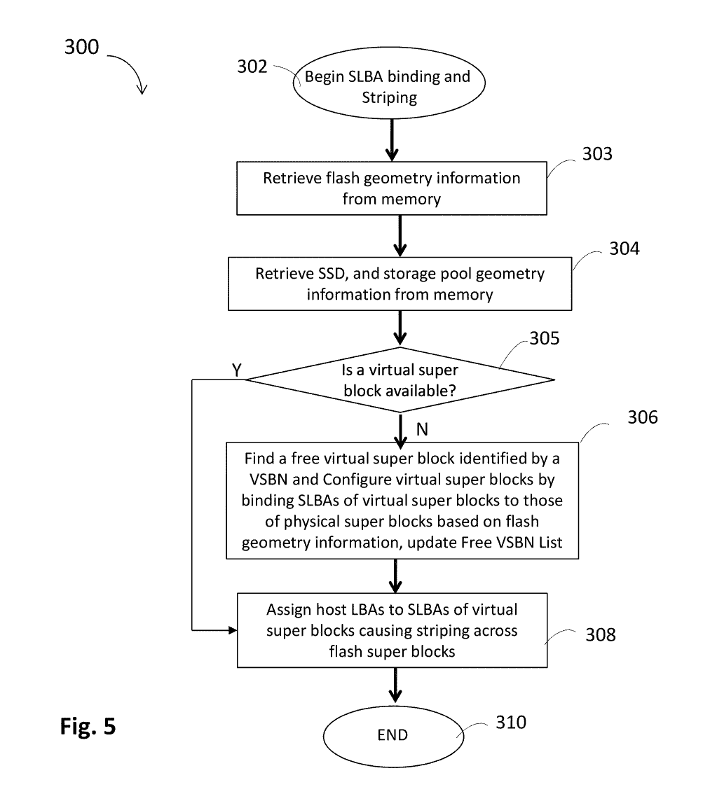

FIG. 5 shows a flow chart of some of the relevant steps performed by the storage processor 10 during binding and striping 302 is shown. The storage processor 10 assigns host-provided LBAs to SLBAs associated with SSDs 28 using geometry information collected from the SSDs. Geometry information refers to particular characteristics of the memory structure of a SSD. For example, geometry information may refer to any combination of the following: SSD and storage pool information (such as the number of dies, number of channels and dies per channel and size of a RAID stripe within SSD, size of RAID strip across SSDs) and Flash information (such as size of a page, number of pages per block and number of blocks (with good data) per die).

At step 303 of the flow chart of FIG. 5, flash geometry information is retrieved by the CPU subsystem 14 from the information 21 in memory 20. Next, at step 304, laSSD and storage pool 26 geometry information is retrieved by the CPU subsystem 14 from geometry info nation 21 in memory 20.

Next, at step 305, the CPU 14 process checks if a virtual super block is available (previously created and not full). If at step 305, it is determined that a virtual super block is available the process moves to step 308, &se the process moves to step 306.

Next, at step 306, the process finds a free VSBN from the list 25b, updates the list 25b and a virtual super block is created (or configured) with corresponding physical (or “flash”) blocks of the SSDs 28. This is done by binding SLBAs of virtual blocks to flash blocks (or “PBAs”). “PBAs” are (physical) addresses that directly identify locations within the SSDs 28, whereas, “SLBAs” are logical addresses that must be translated to physical addresses before being used to identify locations within the SSDs 28.

After step 306, at step 308, host-provided LBAs (or “host LBAs”) are assigned to SLBAs of virtual super blocks. This causes striping across virtual super blocks. A stripe (or RAID stripe) is made of SLBAs of a row of SSDs. The SLBAs may or may not be in like locations of the SSDs. In FIG. 5, the process ends at 310.

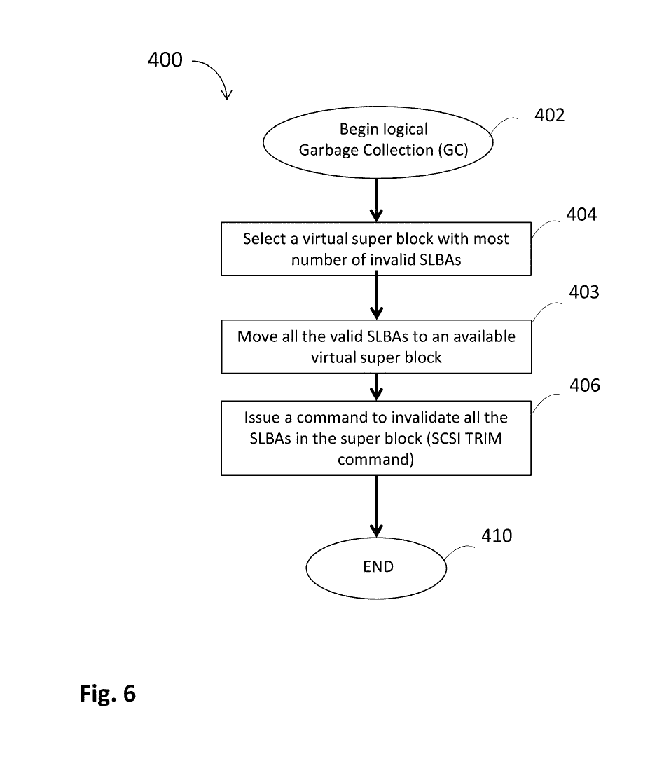

FIG. 6 shows a flow chart of some of the relevant steps performed by the CPU subsystem 14 during garbage collection. At step 402, the process begins. At step 404, a super block with the most number of invalid SLBAs is selected. “Invalid” SLBAs are logical addresses, associated with physical addresses that identify locations within the SSDs 28 with outdated (also referred to herein as “invalid” or “old”) data. Next, at step 403, the valid SLBAs (SLBAs that are not invalid) are all moved to an available virtual super block within the storage pool 26 of the storage system 8. An “available” virtual super block or virtual block) is a configured virtual super block that is not full and hence available for the storage of information. Once the move is completed, all that is left in the virtual super block can be erased.

Next, at step 406, a command, such as, without limitation, the TRIM command, is issued by the CPU subsystem 14 to invalidate all of the SLBAs of the super block, or block.

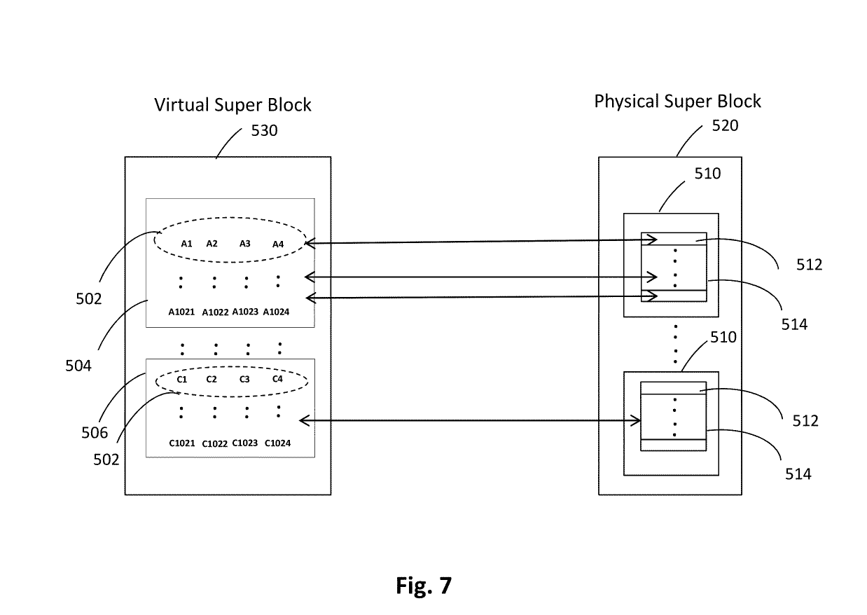

FIG. 7 shows an illustrative embodiment of the correspondence between a virtual super block within an laSSD and a physical super block. In FIG. 7, virtual super block 530 is shown to correspond to the physical super block 520. Within the virtual super block 530 is shown virtual block 504 and virtual block 506 which are examples of virtual blocks that are a part of a virtual super block. Each of the virtual pages 502 are examples of virtual pages of the virtual blocks 504 and 506. Physical super block 520 is shown to include corresponding flash block 514 made of flash pages 512. Each of the flash pages 512 of a flash block 510 is identified by a row of LBAs 502 of the virtual super block 530.

FIG. 8 shows an illustrative, embodiment of a configuration of the flash subsystem 304, in accordance with an embodiment of the invention. The flash subsystem 304 is shown to include X number of dies per channel, “X” being an integer. Each of the dies 1-X is coupled to a distinct channel. For example, dies 1-X of the top row of flash subsystem 304 are all shown coupled to the channel, CH 1, and each of the dies 1-X of a next row are all shown coupled to the channel, CH j, and so on. Y number of channels are shown included in the flash subsystem 304. “Y” being an integer value.

A (physical) super block 603 may be flexibly formed of a row of dies 1-X or of a column of channels, CH 1 through CH Y, with a die, of dies 1-X, included in the super block. Accordingly, a super block may be made of a row 602 or a column 603. Although shown to be in FIG. 8, the dies of a column super block need not be in like locations. It is however easier to address a die with super blocks being in like locations. Obviously, a row of dies forming a super block use the same channel whereas, a column of dies forming a super block are each coupled to a distinct channel

In an embodiment of the invention, the super blocks 603, when formed in columns, may be assigned (or written to) in an order defined by going through each die of the super block and after assignment of the last die of the super block, proceeding to the next super block 603 by assigning the die that is adjacent to the last die of the preceding super block. In another embodiment of the invention where super blocks are made of columns of dies, the order of assignment is defined by starting from the first die of the next super block each time upon completing the assignment of all the dies of a super block. Similarly, for super blocks made of rows of dies, the order of assignment may be to proceed to the adjacent die of the next super block, upon completion of assignment of the dies of the preceding super block or to start with the first die of a super block each time the dies of a new super block is being assigned. The above are examples as ordinary skilled in the art with the aid of this disclosure can construct other ways which all fall in the spirit of invention.

FIG. 9A shows an illustrative embodiment of a RAID group and super blocks formed across a group of SDDs, in accordance with an embodiment of the invention. More specifically three distinct SSDs 28, i.e. SSD 1, SSD n and SSD N, of a RAID group comprising N SSDs are shown, which collectively, make up a RAID group, i.e. RAID group m 900, RAID group m 900 is one of the RAID groups shown within the storage pool 26 in earlier-discussed FIGS. 1-2. Each of the SSDs 28 are shown to include dies 1-X, channels CR 1-Y, and a module controller 302. Further shown in FIG. 9A, are exemplary RAID super block 903, 904 and 906. Each of these RAID super blocks is shown made of a block of one die per SSD. For example, RAID stripe 903 is shown formed of a block in die 1 802 of the SSD 1, a block die I of SSD n, and a block of die 1 of SSD N. As previously noted, while the blocks of super block 903 are shown to include blocks in like-locations, blocks of a super block need not be in like-positions. For instance, a RAID stripe may be formed of die 1 of SSD 1, die i of SSD n, and die X of SSD N. This is an example of RAID group across the SSDs.

FIG. 9B shows an illustrative embodiment of LBA organization of a virtual super block across a laSSD group. In FIG. 9B, three SSDs of a laSSD group are shown and are each a part of two super blocks 406. That is, each of the virtual super blocks 406 spans laSSDs m-1 thru m-N. Each of these virtual super blocks includes different rows of pages of each of the laSSDs m-1, thru m-N. For instance, one of the super blocks 406 encompasses page 402 of each of the laSSDs thru m-N through the last page defining a block 404. Stated differently, each of the blocks 404 are formed of a number of pages 402 within a laSSD. Each of the pages 402 of the LBA organization within each of the laSSDs m-1 through m-N, is shown to include LBAs A1-A4 through A1021-A1024.

Although the embodiments of the invention has been described in terms of specific embodiments, it is anticipated that alterations and modifications thereof will no doubt become apparent to those skilled in the art. It is therefore intended that the following claims be interpreted as covering all such alterations and modification as fall within the true spirit and scope of the invention.

What is claimed:

1. A method of managing a solid state disk (SSD) comprising:
maintaining flash geometry information of the SSD;
maintaining SSD geometry information of the SSD; and
based on the flash geometry information and the SSD geometry information, configuring virtual super blocks by dynamically binding SSD logical block addresses (SLBAs) of a virtual super block to a physical super block within the SSD, the bound SLBAs identifying locations of the physical super blocks within the SSD to which the bound SLBAs are bound, a virtual super block being a plurality of virtual blocks and each virtual block having a plurality of virtual pages, each of the virtual blocks corresponding to a physical block of a physical super block within the SSD such that the virtual pages of the virtual block correspond to like physical pages of a physical block of the SSD; and
assigning host logical block addresses (LBAs) to the bound SLBAs to stripe across physical super blocks of the SSD therefore causing striping across corresponding virtual super blocks.

2. The method of managing of claim 1, wherein physical blocks of the SSD each have block sizes associated therewith and further wherein a central processing unit (CPU) performing the binding step and further wherein each virtual block having a predetermined number of SLBAs based on the flash geometry information.

3. The method of managing of claim 2, wherein the predetermined number of SLBAs is based on the size of a block within the SSD.

4. The method of managing of claim 2, wherein the SLBAs of the predetermined number of SLBAs is sequential.

5. The method of managing of claim 1, further including performing garbage collection and after completion of the garbage collection step, repeating the binding step.

6. The method of managing of claim 1, further including receiving a host command including host LBAs.

7. The method of managing of claim 1, further including writing to SLBAs of virtual pages of a virtual super block causing automatically writing to a physical pages of a corresponding bound physical super block.

8. The method of managing of claim 1, further including writing to data blocks within the SSD, identified by SLBAs of a virtual block causing writing to a physical block of a physical super block to which SLBAs are bound therefore causing writing to a virtual block of a virtual super block, the location of the virtual block within the SSD being identifiable by the bound SLBAs.

9. The method of managing of claim 1, further including relocating valid SLBAs of a virtual super block bound to a physical super block to another physical super block associated with another virtual super block.

10. The method of managing of claim 9, wherein after the relocation step, reclaiming the physical super block to which the virtual super block is bound by sending one or more TRIM commands to the SSD.

11. The method of managing of claim 10, wherein invalid SLBAs identify outdated data blocks and valid SLBAs identify current data blocks.

12. The method of managing of claim 1, further including selecting a virtual super block with a most number of invalid SLBAs, moving the valid SLBAs to an available virtual super block, and issuing a command to invalidate the SLBAs of the selected virtual super block.

13. The method of managing of claim 12, wherein the issuing step including issuing a TRIM command.

14. The method of managing of claim 1, further including striping across physical super blocks of the SSD and avoiding starting another striping step until after completion of the striping step.

15. A method of managing a plurality of solid state disk (SSDs) comprising:
maintaining flash geometry information of the SSDs;
maintaining SSD geometry information of the SSDs; and
based on the flash geometry information and the SSD geometry information, configuring virtual super blocks of the SSDs by dynamically binding SSD logical block addresses (SLBAs) of the virtual super blocks to physical super blocks, the bound SLBAs identifying locations of the physical super blocks to which the SLBAs are bound, a virtual super block being a plurality of virtual blocks with each virtual block having a plurality of virtual pages, each of the virtual blocks corresponding to a physical block of a physical super block such that each of the virtual pages of the virtual block correspond to like physical pages of a physical block of the SSDs and at least some of the super physical blocks or at least some of the super virtual blocks spanning more than one SSD; and
assigning host logical block addresses (LBAs) to the bound SLBAs to stripe across physical super blocks of the SSDs therefore causing striping across corresponding virtual super blocks.

16. The method of managing of claim 15, wherein physical blocks within the SSDs each have block sizes associated therewith and further wherein a central processing unit (CPU) performing the binding step and each virtual block being identifiable by a predetermined number of SLBAs based on the flash geometry information.

17. The method of managing of claim 16, wherein the predetermined number of SLBAs is based on the size of a data block within the SSDs.

18. The method of managing of claim 15, wherein the SLBAs are sequential.

19. The method of managing of claim 15, wherein performing garbage collection and after the garbage collection step, repeating the binding step.

20. The method of managing of claim 15, further including receiving a host command including host LBAs.

21. The method of managing of claim 15, further including writing to SLBAs of virtual pages of a virtual super block causing automatically writing to a physical pages of a corresponding physical super block.

22. The method of managing of claim 15, further including writing to data blocks of the SSDs, locations of which in the SSDs identified by SLBAs of virtual blocks, causing writing to physical blocks bound to corresponding virtual blocks and associated SLBAs.

23. The method of managing of claim 15, further including relocating the valid SLBAs of a virtual super block bound to a physical super block to another physical super block with an associated virtual super block.

24. The method of managing of claim 23, wherein after the relocating step, reclaiming the physical super block to which a SLBAs are bound by sending one or more TRIM commands to the SSD.

25. The method of managing of claim 23, wherein invalid SLBAs identifying outdated data blocks and valid SLBAs identifying current data blocks.

26. The method of managing of claim 15, further including selecting a virtual super block with a most number of invalid SLBAs and moving the valid SLBAs to an available virtual super block, and issuing a command to invalidate the SLBAs of the selected virtual super block.

27. The method of managing of claim 26, wherein the issuing step including issuing a TRIM command.

28. The method of managing of claim 15, further including striping across physical super blocks of the SSDs and avoiding starting another striping step until after completion of the striping step.
